(19) United States
(12) Patent Application Publication
(10) Pub. No.: US 2010/0054467 A1
(43) Pub. Date: Mar. 4, 2010

(54) IMAGE FORMING SYSTEM AND SECURITY PRINTING METHOD THEREOF

(75) Inventor: Young-taek CHO, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/544,450

(22) Filed: Aug. 20, 2009

(30) Foreign Application Priority Data
Sep. 3, 2008 (KR) 10-2008-0086853

(51) Int. Cl. G09C 5/00; G06F 3/12

(52) U.S. Cl. 380/51; 358/1.15

(57) ABSTRACT

An image forming system and a security printing method of the image forming system. The security printing method of the image forming system may include receiving print data in an image forming apparatus, determining whether the received print data includes an authenticated encryption code, and if it is determined that the print data does not include the authenticated encryption code, forming an image to include an image to indicate that the print may not be a print by security print. The security printing method have an advantage of performing a print operation to print data authenticated by a host device with no security application or even in print performance by Direct Printing, with strengthened security.

### CROSS-REFERENCE TO RELATED APPLICATIONS

This application claims priority under 35 U.S.C. §119(a) of Korean Patent Application No. 10-2008-0086853, filed on Sep. 3, 2008 in the Korean Intellectual Property Office, the disclosure of which is incorporated herein by reference.

### BACKGROUND

1. Field of the Invention

The present general inventive concept relates to forming an image and printing the image with security, and more particularly, to forming an image and printing the image with strengthened security for print data.

2. Description of the Related Art

With recent change in work environments of enterprises that use computers, networks, the Internet, and so on, efforts have been increasingly made to protect confidential data, such as important documents, drawings, and so on, to be exclusively used by enterprises against theft, outflow, loss, and so on.

Accordingly, enterprises have increasingly been interested in security print to allow only an authenticated document to be printed for the purpose of preventing confidential documents of enterprises from being flown out and lost.

For such security print, in the related art, an application to provide a security function is installed in a host device which adds host information such as user information, data, and the like to print data using the application and transmits the print data and the host information to a management server.

The management server receives the print data and determines whether the received print data is authenticated, and transmits authenticated print data to an image forming apparatus. The image forming apparatus receives the print data including the host information from the management server and performs a print operation to form an image including the host information.

However, in case of performing a print operation through a host device with no security application or in case of a Direct Printing where an image forming apparatus performs a print operation for print data stored in a portable storage medium or the like with no host device, the above-described conventional security print has a problem that the print operation is performed irrespective of authentication of the print data.

### SUMMARY

Accordingly, the present general inventive concept provides an image forming system with strengthened security, which is capable of performing a print operation to print data authenticated by a host device with no security application or even in print performance by Direct Printing, and a security printing method of the image forming system

Additional features and utilities of the present general inventive concept will be set forth in part in the description which follows and, in part, will be obvious from the description, or may be learned by practice of the general inventive concept.

Embodiments of the present general inventive concept can be achieved by providing a security printing method of an image forming system including an image forming apparatus, a host device to generate print data, and a management server to authenticate the generated print data, the method may include receiving print data in the image forming apparatus, determining whether the received print data includes an authenticated encryption code; and if it is determined that the print data does not include the authenticated encryption code, forming an image including an image to indicate that the print is not a print by security print.

The security printing method may further include, if it is determined that the received print data does not include the authenticated encryption code, outputting an error message.

The outputting an error message may include to select whether a print operation is performed for the print data.

The print data including the encryption code may be generated in the host device. Here, the encryption code may use print job language (PJL).

The forming an image may include an image including at least one of information of the host device in which the print data can be generated, and information of the image forming apparatus which may perform the print operation. Here, the information of the host device may be added in the management server.

The receiving print data may include receiving the print data from the host device without passing through the management server or directly receiving the print data from the image forming apparatus without the host device. Here, the directly received print data from the image forming apparatus may include receiving the print data from a portable storage medium.

Embodiments of the present general inventive concept can be achieved by providing an image forming system including an image forming apparatus, a host device to generate print data, and a management server to authenticate the generated print data, wherein the image forming apparatus may include a communicating unit to receive print data, an image forming unit to form an image for the received print data, and a controller to determine whether the received print data includes an authenticated encryption code, and, if it is determined that the print data does not include the authenticated encryption code, to control the image forming unit to form an image including a supplemental image to indicate that the print may not be performed by security print.

The image forming system may further include a display unit to output an error message, if it is determined that the received print data does not include the authenticated encryption code.

The image forming system may further include a user interface to select whether a print operation may be performed for the print data.

The print data may include the encryption code to be generated in the host device. Here, the encryption code may use print job language (PJL).

The image forming unit may form an image to include at least one of information of the host device in which the print data may be generated, and information of the image forming apparatus to perform the print operation. Here, the information of the host device may be added in the management server.

The communicating unit may receive the print data from the host device without passing through the management server or directly receive the print data from the image forming apparatus without the host device.

Embodiments of the present general inventive concept may include a computer readable medium to contain computer readable code as a program to perform a method of an image forming system, the method including receiving print data in the image forming apparatus, determining whether the received print data includes an authenticated encryption code, and determining if the print data does not include the authenticated encryption code, forming an image including an image indicating that the print is not a print by security print.

Embodiments of the present general inventive concept may include an image forming system to provide secure printing, including a host device to generate and transmit print data, which may include encryption code for authentication, to an image forming apparatus.

Embodiments of the present general inventive concept may include an image forming system to provide secure printing, including a management server to intercept print data transmitted between a host device and an image forming apparatus, to compare and verify authenticity of the print data with information stored in the management server, and to determine and notify the image forming apparatus whether an image formed based on the print data should include information of the host device.

Embodiments of the present general inventive concept may include an image forming system to provide secure printing, including a host device to generate and transmit print data, which may include encryption code for authentication, to an image forming apparatus, and a management server to intercept print data transmitted between the host device and the image forming apparatus, to compare and verify authenticity of the print data with information stored in the management server, and to determine and notify the image forming apparatus whether an image formed based on the print data should include information of the host device.

Embodiments of the present general inventive concept may include an image forming system to provide secure printing, including a image forming apparatus including an image forming unit, and a controller to review received print data to find any encryption code encoded within the print data and control the formation of an image based upon the print data without any error notification, if encryption code is authenticated.

Embodiments of the present general inventive concept may include an image forming system to provide secure printing, including a host device to generate and transmit print data, which may include encryption code for authentication, to an image forming apparatus, a management server to intercept print data transmitted between the host device and the image forming apparatus, to compare and verify authenticity of the print data with information stored in the management server, and to determine and notify the image forming apparatus whether an image formed based on the print data should include information of the host device, and a image forming apparatus including an image forming unit, and a controller to review received print data to find any encryption code encoded within the print data and control the formation of an image based upon the print data without any error notification, if encryption code is authenticated.

### BRIEF DESCRIPTION OF THE DRAWINGS

Embodiments of the present general inventive concept will become apparent and more readily appreciated from the following description of the exemplary embodiments, taken in conjunction with the accompanying drawings, in which:

FIG. 1 is a block diagram illustrating an image forming system according to an exemplary embodiment of the present general inventive concept.

FIG. 2 is a block diagram illustrating an image forming apparatus according to an exemplary embodiment of the present general inventive concept.

FIG. 3 is a view illustrating an example of print data including a encryption code according to an exemplary embodiment of the present general inventive concept.

FIGS. 4 and 5 are views illustrating an example of printed matter output by security print according to an exemplary embodiment of the present general inventive concept.

FIG. 6 is a flow chart illustrating a security printing method of an image forming system according to an exemplary embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to like elements throughout. The embodiments are described below so as to explain the present general inventive concept by referring to the figures.

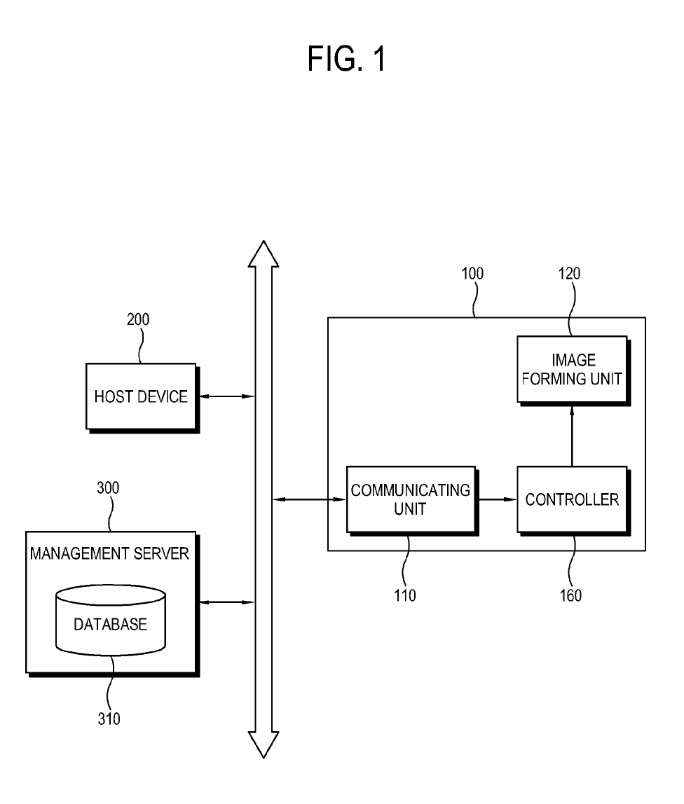

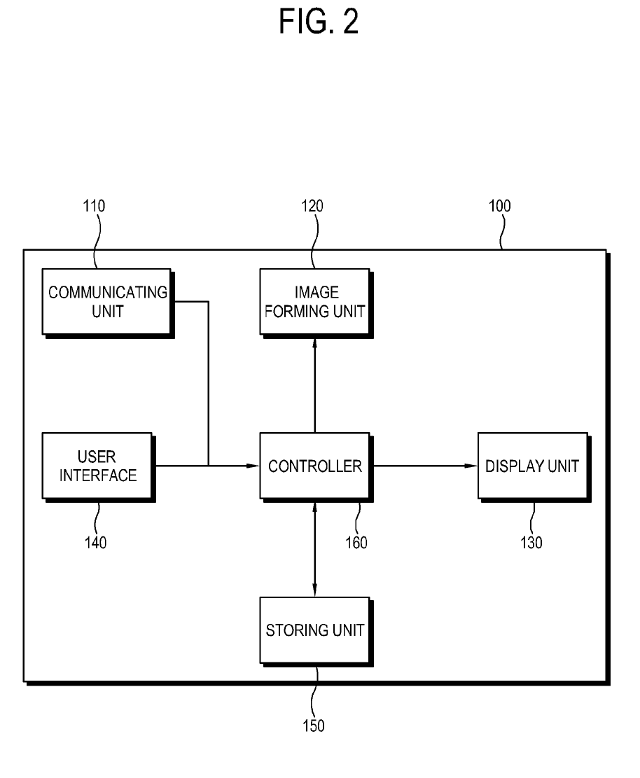

FIG. 1 is a block diagram illustrating an image forming system 10 according to an exemplary embodiment of the present general inventive concept, and FIG. 2 is a block diagram illustrating an image forming apparatus 100 in FIG. 1. An image forming system 10 may include an image forming apparatus 100, a host device 200, and a management server 300.

The image forming apparatus 100 may be implemented as a printer, a copier, a fax, a multifunction copier with two or more functions, or the like. The host device 200 and the management server 300 may be implemented as a personal computer (PC). As the case may be, the host device 200 may include the management server 300. The image forming apparatus 100, the host device 200, and the management server 300 may be interconnected by a network or a local manner, and the image forming apparatus 100 and the host device 200 may be provided in the plural number.

The image forming apparatus 100 according to an exemplary embodiment of the present general inventive concept may print print data on a recording medium, such as paper. In this case, a print may include a print for copy of a manuscript after scanning the manuscript, a print of received fax data, a print of print data received from the outside through a host device including a server or stored in internal storage (hard disk drive, HDD) of the image forming apparatus 100 or external storage (a portable storage medium, such as a universal serial bus (USB) memory device) and so on.

As illustrated in FIG. 1, the image forming apparatus 100 may include a communicating unit 110, an image forming unit 120 and a controller 160. In addition, the image forming apparatus 100 according to this embodiment may further include a display unit 130, a user interface 140, and a storing unit 150, as illustrated in FIG. 2.

The communicating unit 110 may receive print data written by a certain print language from the outside. The communicating unit 110 may include a wired/wireless communicating module, which may be connected to an external device such as the host device 200 in a local manner or by a network, a USB port, which may be connected to an external storage medium (portable storage medium) such as a USB memory device, or the like.

Here, the print data may include encryption codes written by a print language such as Print Job Language (PJL).

More specifically, the print data to generate in the host device 200 through a printer driver or the like may include encryption codes authenticated by security print (hereinafter also referred to as “SecuPrint”).

Security print may constitute a method of controlling and directing print jobs. In particular, security print may act as a security system for print jobs, wherein overall control of print jobs is provided. For example, information added to the print data of a document using the security print may be encrypted with certain encryption code predetermined by the host device 200.

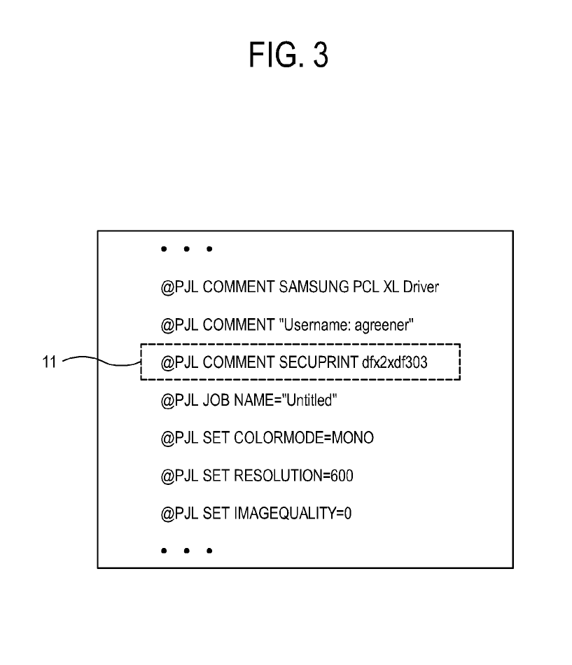

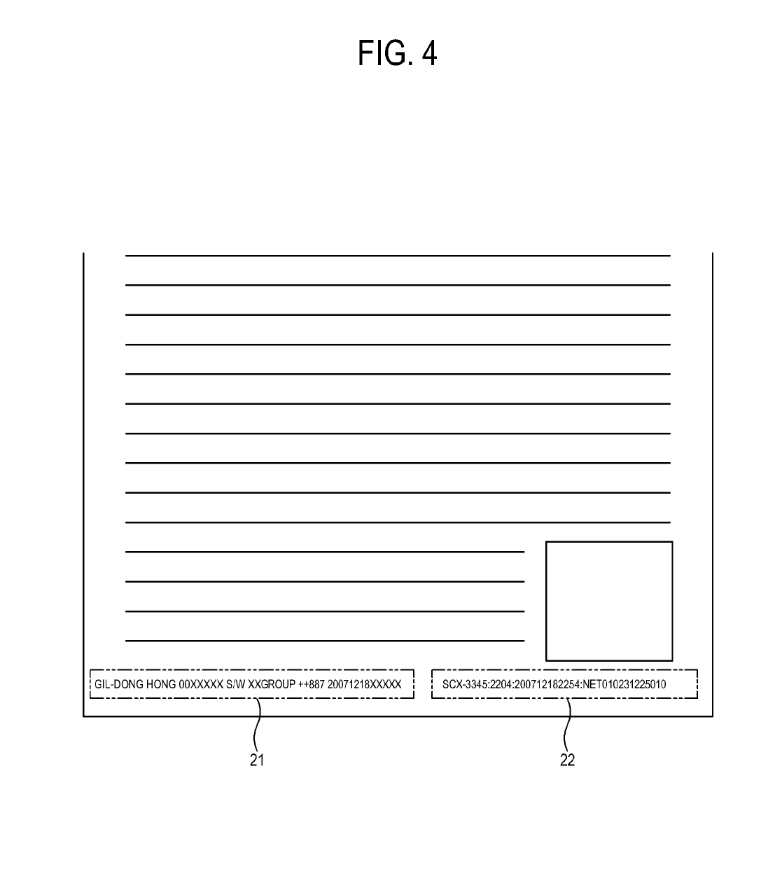

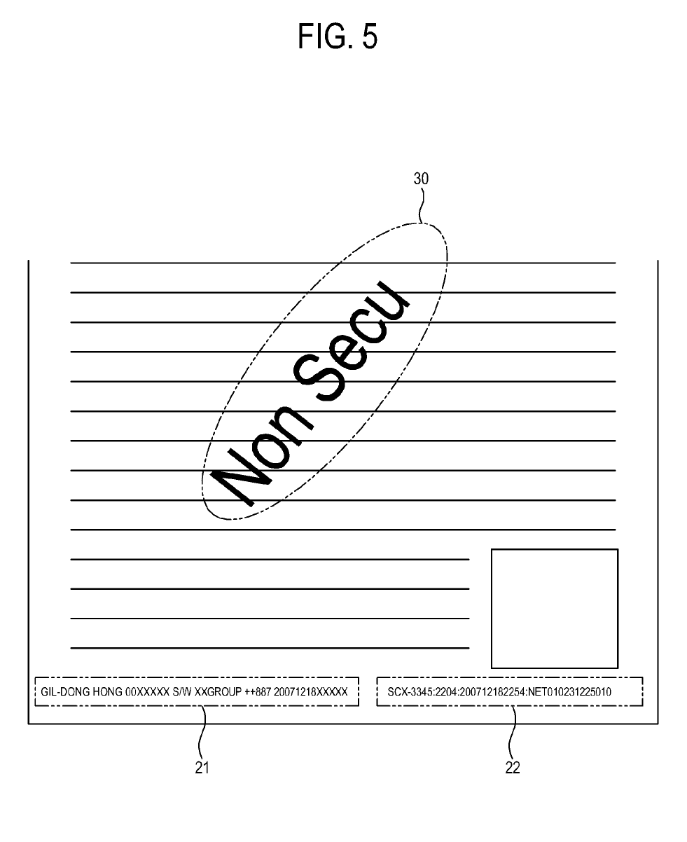

FIG. 3 is a view illustrating an example of print data including a encryption code according to an exemplary embodiment of the present general inventive concept, and FIGS. 4 and 5 are views illustrating an example of printed matter output by security print according to an exemplary embodiment of the present general inventive concept.

As illustrated in FIG. 3, information added to the print data of a document to be printed using the security print may become a encryption code 11, which may encrypt contents of a particular location of the document.

In this case, the encryption may be made by encoding a header portion of the print data by means of a predetermined encryption code, and the encrypted additional information may be composed of 10 bytes.

As described above, since the information added by using the security print may be generated according to the encryption method predetermined by the host device 200 and the image forming apparatus 100, a user can not add information, such as encryption code, to the print data arbitrarily. In addition, the encryption code 11 may be added according to the predetermined encryption method to become an authenticated encryption code.

The print data may include the encryption code generated in the host device 200 to transmit to the image forming apparatus 100 through the management server 300 via a network or local connection or may be stored in a portable storage medium for later transmission to the image forming apparatus 100. The portable storage medium may include at least one of a USB memory device, a memory card like a memory stick, a compact flash (CF) card or a multi-media card (MMC), and a portable device having a storage, such as a digital camera or a mobile phone.

Although it is illustrated in an exemplary embodiment of the present general inventive concept that the encryption code 11 may be generated using print job language (PJL) as illustrated in FIG. 3, the encryption code according to the security print may be usable with a variety of different print languages including print control language (PCL), postscript (PS), graphic device interface (GDI), and so on, instead of PJL.

The generated print data may be transmitted to the image forming apparatus 100 through the management server 300. The management server 300 may transmit and/or may receive the print data to/from the image forming apparatus 100 and the host device 200 and may include a database 310 (see FIG. 1) to store print information such as a file name, file size, file kind, and the like of the transmitted/received print data, host information such as an address, user information, and the like of the host device 200, and printer information such as a kind, resolution, print speed, and the like of the image forming apparatus 100. The database 310 may further store security information of a particular file inhibited from being printed, a person who permits printing of a file, and the like.

The management server 300 may intercept the print data transmitted from the host device 200 to the image forming apparatus 200, compare the print data with the information stored in the database 310 to determine whether the print data may be allowed to be printed, and, if allowed, enable the image forming apparatus 100 to print the print data.

As illustrated in FIGS. 4 and 5, the print data particular to a document and allowed to be printed by the management server 300 may be printed with host information 21 added to a particular position of the document (for example, on the bottom side of the document). Also, the host information may include an address, user information, and the like of the host device 200 by which the print data may be generated, and the user information may include a name, post, employee number, and the like of a user.

The image forming apparatus 100 may receive the print data through the communicating unit 110 and the received print data may be formed as an image and output by the image forming unit 120.

The image forming unit 120 may form an image to be printed on paper based on the print data. Specifically, the image forming unit 120 may form the image if the received print data includes an authenticated encryption code.

In other words, the controller 160 may determine whether the print data received from the outside according to a print instruction includes the authenticated encryption code 11.

For example, in case of the print data to be generated by PJL, as illustrated in FIG. 3, the controller 160 may determine whether the received print data includes the encryption code 11, that is, an item “PJL COMMENT SECUPRINT.”

In this case, if the print data includes the encryption code 11, the controller 160 may decode the encryption code and determine whether the decoded encryption code is a encryption code generated according to the encryption method predetermined by the host device and the image forming apparatus 100, that is, an authenticated encryption code.

If it is determined that the print data includes the authenticated encryption code 11, the controller 160 may control the image forming unit 120 to form an image based on the received print data. Here, if the print data is to authenticate through the management server 300, the controller 160 may control the image forming unit 120 to form an image including the host information 21 as illustrated in FIG. 4. Accordingly, the image forming apparatus 100 according to an exemplary embodiment of the present general inventive concept may perform security print using the encryption code 11 for print data which may be received from the host device 200 without passing through the management server 300 (for example, a host device with no security application) or may be received by a Direct Printing through a portable storage medium such as a USB memory device without host device 200, in addition to the authentication of the print data through the management server 300.

On the other hand, if the print data includes the authenticated encryption code 11, the controller 160 may control the image forming unit 120 to form an image to further include printer information 22 as illustrated in FIG. 4.

Specifically, the controller 160 may control the image forming unit 120 to form an image with the printer information 22 added to a particular position of a rendered image (for example, on the bottom side of a document). Here, the printer information 22 may include a brand (model name), resolution, management number, print speed, address information, and the like of the image forming apparatus 100, which may perform the print operation.

Accordingly, if the print data includes the authenticated encryption code, the image forming unit 120 may form and print an image to include at least one of the host information 21 and the printer information 22 under control of the controller 160.

In this case, the controller 160 may control the image forming unit 120 to convert the host information 21 and the printer information 22 into a text image composed of black (1) and white (0) and may form an image by performing an OR operation for the text image and the image formed by the print data.

On the other hand, if the received print data does not include the encryption code 11 or the included encryption code is an unauthenticated encryption code, the controller 160 may display an error message indicating that the print data may not be authenticated, through the display unit 130.

The display unit 130 may include a thin film transistor-liquid crystal display (TFT-LCD) and a driver (not illustrated), which may drive the TFT-LCD.

The controller 160 may cause a user to select whether to continue to print the print data through the user interface 140 in response to the display error message.

If the user selects continuation of print of the print data, the controller 160 may control the image forming unit 120 to form an image including a non-security print (Non SecuPrint) image 30 to indicate that the print data may not be authenticated, as illustrated in FIG. 5.

In other words, if the user selects the continuation of print of the print data through the user interface 140 for all print data with unauthenticated encryption code 11, the controller 160 may control the image forming unit 120 to form an image with the image 30 added to the rendered image, which may indicate that the print may not be performed by a security print, as illustrated in FIG. 5. Specifically, the controller 160 may control the image forming unit 120 to perform an OR operation for the non-security print image 30, which may indicate that the print is not performed by a security print, and the image formed based on the print data may therefore include two superimposed images. Here, the non-security print image 30 may be an image such as a watermark.

Accordingly, since an output printed matter may indicate that the printed matter is not a printed matter authenticated by security print as illustrated in FIG. 5, and since the printed matter may include the host information 21 and the printer information 22, it may be possible to grasp an information outflow path.

In this case, the non-security print image 30 may be an image pre-stored in the storing unit 150 provided inside or outside the image forming apparatus 100.

In addition, if a user selects stop of the print in response to the error message displayed on the display unit 130, the controller 160 may control the image forming unit 120 to stop the print operation, and may display a message to indicate the end of the print operation through the display unit 130.

On the other hand, as the case may be, if the print data does not include the authenticated encryption code 11, the controller 160 may stop the print operation irrespective of selection of the user and may display a message indicating the end of the print operation through the display unit 130.

The controller 160 may store a print record according to the security print to include the stop of the print operation in the storing unit 150 for later utilization in the event of document outflow.

The user interface 140 may include a panel (including key buttons) to indicate functions of the image forming apparatus 100, or a graphics user interface (GUI) displayed on the display unit 130, which may be generated by execution of a printer driver or a separate application to allow a user to input information or data.

If the user interface 140 includes a GUI and the print data does not include authenticated encryption code 11, the controller 160 may display the GUI through which the user may select continuation or stop of the print operation.

In addition, if the image forming apparatus 100 performs a Directing Printing, and for example, if a portable storage medium is mounted into in the image forming apparatus 100, the controller 160 may display the GUI through which the user may select a file to be printed of files stored in the portable storage medium.

The controller 160 may control the image forming apparatus 100 as a whole. Specifically, upon receiving the print data via the communicating unit 110, the controller 160 may determine whether the received print data includes the authenticated encryption code 11, and, based on this determination, may control the image forming unit 120 to perform or stop the print operation. Here, if the print data may be print data authenticated through the management server 300, an image may include the host information 21 may be formed.

In addition, if the print data does not include the authenticated encryption code 11, the controller 160 may control the display unit 130 to display an error message and may control the image forming unit 120 to form an image to further include the non-security print image 30 or stop the print operation based on a result of selection for stop of the print operation through the user interface 140.

Thus, according to an exemplary embodiment of the present general inventive concept, since not only the management server 300 but also the image forming apparatus 100 may determine whether the print data includes the authenticated encryption code and the print operation may be performed or stopped based on a result of the determination, a security print can be usable with print data generated in a host device with no security application or print by Direct Printing.

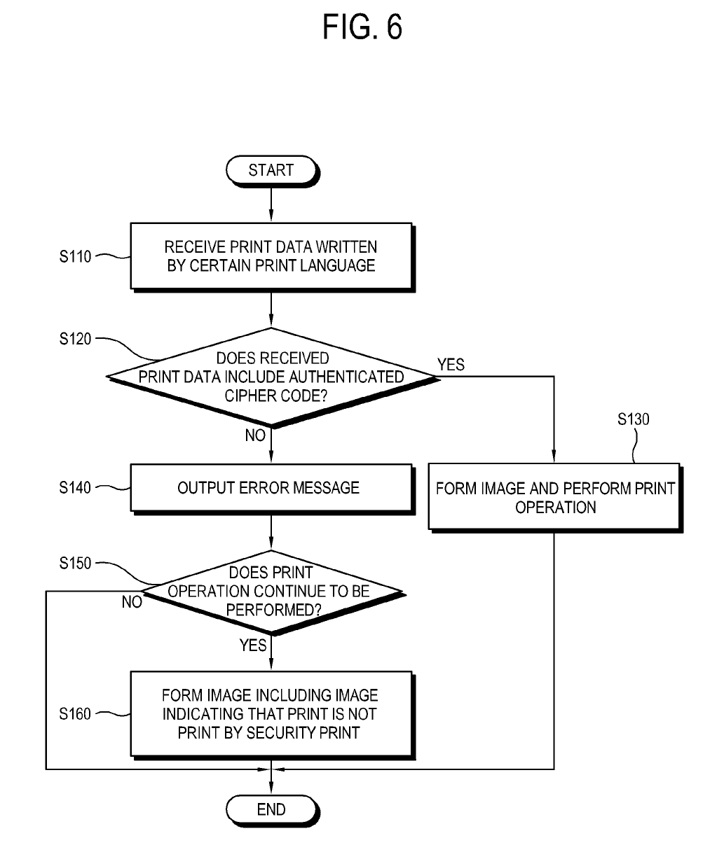

Hereinafter, a security printing process in the image forming system 10, as constructed above, will be described with reference to FIG. 6.

First, the image forming apparatus 100 may receive print data written by a certain print language (S110). In this case, the received print data may be a) print data generated in the host device 200 and authenticated through the management server 300 connected to the host device 200 via a network or a local connection, b) print data received from the host device 200 without passing through the management server 300, or c) print data received from a portable storage medium such as a USB memory according to a Direct Printing method irrespective of authentication by the management server 300.

Next, the controller 160 may determine whether the received print data includes the authenticated encryption code 11 (S120). In this case, the encryption code may encrypt contents of a particular position of a document and may be made by encoding a header portion of the print data by means of an encryption code predetermined by the host device 200 and the image forming apparatus 100. Such a encryption code added according to the predetermined encryption method may become an authenticated encryption code.

If it is determined in operation S120 that the print data may include the authenticated encryption code 11, the controller 160 may control the image forming unit 120 to form an image and perform a print operation. Here, the image forming unit 120 may perform the print operation with at least one of the host information 21 and the printer information 22 added to a particular position of a document. The host information 21 may be added if the print data is to be received through the management server 300.

If it is determined in operation S120 that the print data does not include the authenticated encryption code 11 or the encryption code is unauthenticated, the controller 160 may display an error message on the display unit 130 (S140).

The image forming apparatus 100 may select through the user interface 140 whether the print operation may continue to be performed in response to the error message displayed in operation S140 (S150).

If it is selected in operation S150 that the print operation may continue to be performed, the controller 160 may control the image forming unit 120 to form an image including the non-security print image 30 to indicate that the print may not be performed by security print.

If it is selected in operation S150 that the print operation is stopped, the controller 160 may control the image forming unit 120 to stop the print operation. In this case, the image forming apparatus 100 may inform a user through the display unit 130 that the print operation is ended.

On the other hand, if it is determined in operation S120 that the print data does not include the authenticated encryption code 11, the controller 160 may stop the print operation and may control the display unit 130 to display the end of the print operation.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described above, the image forming system and the security printing method thereof have an advantage to perform a print operation for print data authenticated by a host device with no security application or even in print performance by Direct Printing, with strengthened security.

Although a few exemplary embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A security printing method of an image forming system including an image forming apparatus, a host device to generate print data, and a management server to authenticate the generated print data, the method comprising:
receiving print data in the image forming apparatus;
determining whether the received print data includes an authenticated encryption code; and
determining if the print data does not include the authenticated encryption code, forming an image including an image indicating that the print is not a print by security print.

2. The security printing method according to claim 1, further comprising:
determining if the received print data does not include the authenticated encryption code, outputting an error message.

3. The security printing method according to claim 2, wherein outputting an error message comprises:
selecting whether a print operation is performed for the print data.

4. The security printing method according to claim 1, wherein the print data including the encryption code are generated in the host device.

5. The security printing method according to claim 4, wherein the encryption code uses a print job language (PJL).

6. The security printing method according to claim 1, wherein the forming an image comprises:
an image including at least one of information of the host device in which the print data is generated, and information of the image forming apparatus which performs the print operation.

7. The security printing method according to claim 6, wherein the information of the host device is added in the management server.

8. The security printing method according to claim 1, wherein the receiving print data comprises:
receiving the print data from the host device without passing through the management server or directly receiving the print data from the image forming apparatus without the host device.

9. The security printing method according to claim 8, wherein the directly receiving the print data from the image forming apparatus comprises:
receiving the print data from a portable storage medium.

10. An image forming system including an image forming apparatus, a host device to generate print data, and a management server to authenticate the generated print data, wherein the image forming apparatus comprises:
a communicating unit to receive print data;
an image forming unit to form an image for the received print data; and
a controller to determine whether the received print data includes an authenticated encryption code, and, if it is determined that the print data does not include the authenticated encryption code, to control the image forming unit to form an image including a supplemental image indicating that the print is not performed by security print.

11. The image forming system according to claim 10, further comprising:
a display unit to output an error message, if it is determined that the received print data does not include the authenticated encryption code.

12. The image forming system according to claim 11, further comprising:
a user interface to select whether a print operation is performed for the print data.

13. The image forming system according to claim 10, wherein the print data including the encryption code may be generated in the host device.

14. The image forming system according to claim 13, wherein the encryption code may use a print job language (PJL).

15. The image forming system according to claim 10, wherein the image forming unit may form an image to include at least one of information of the host device in which the print data is generated, and information of the image forming apparatus to perform the print operation.

16. The image forming system according to claim 15, wherein the information of the host device may be added in the management server.

17. The image forming system according to claim 10, wherein the communicating unit may receive the print data from the host device without passing through the management server or may directly receive the print data from the image forming apparatus without the host device.

18. An image forming system to provide secure printing, comprising:
a host device to generate and transmit print data, which may include encryption code for authentication, to an image forming apparatus;
a management server to intercept print data transmitted from the host device, to compare and verify authenticity of the print data with information stored in the management server, and to determine and notify whether an image to be formed based on the print data should include information of the host device;
a image forming apparatus comprising an image forming unit; and
a controller to review received print data to find any encryption code encoded within the print data and control the formation of an image based upon the print data without any error notification, if encryption code is authenticated.
